(19) United States
(12) Patent Application Publication
(10) Pub. No.: US 2018/0142434 A1
(43) Pub. Date: May 24, 2018

(54) FRICTION PENDULUM ISOLATION BEARING, INTELLIGENT BEARING AND INTELLIGENT MONITORING SYSTEM

(71) Applicants: Shenzhen Municipal Design & Research Institute Co., Ltd., Shenzhen City (CN); Shenzhen Innova-Wise Engineering Technology Consulting Co., Ltd., Shenzhen City (CN)

(72) Inventors: Fang YU, Shenzhen City (CN); Ruijuan Jiang, Shenzhen City (CN); Yiyan Chen, Shenzhen City (CN); Weiming Gai, Shenzhen City (CN); Jie Peng, Shenzhen City (CN); Jucan Dong, Shenzhen City (CN)

(73) Assignees: Shenzhen Municipal Design & Research Institute Co., Ltd., Shenzhen City (CN); Shenzhen Innova-Wise Engineering Technology Consulting Co., Ltd., Shenzhen City (CN)

(21) Appl. No.: 15/865,182

(22) Filed: Jan. 8, 2018

Related U.S. Application Data
(63) Continuation of application No. PCT/CN2016/097565, filed on Aug. 31, 2016.

(30) Foreign Application Priority Data
Jul. 18, 2016 (CN) 201610565650X

(51) Int. Cl. E01D 19/04; G01L 5/00

(52) U.S. Cl. CPC E01D 19/042; G01L 5/0019

(57) ABSTRACT

A fiction pendulum isolation bearing, an intelligent bearing and a bearing monitoring system are disclosed. The fiction pendulum isolation bearing comprises a top bearing plate, a bottom bearing plate, a top hinge, a bottom hinge, a base plate stacked with the top bearing plate or the bottom bearing plate, and a pressure sensing unit arranged between the top bearing plate and the base plate or between the bottom bearing plate and the base plate. The intelligent bearing comprises a data acquisition unit, a data output unit and the friction pendulum isolation bearing, wherein the data acquisition unit is configured to transmit the bearing pressure measured by the pressure sensing unit to the data output unit. The bearing monitoring system comprises a data acquisition unit, a data output unit, a monitoring center and the friction pendulum isolation bearing.

This application is a Continuation of PCT Application No. PCT/CN2016/097565, filed Aug. 31, 2016, which is hereby incorporated by reference.

### FIELD OF THE INVENTION

The present invention relates to the technical field of bearings, and more particularly to a fiction pendulum isolation bearing, an intelligent bearing and a bearing monitoring system.

### BACKGROUND OF THE INVENTION

Currently, isolation bearings are widely used in the field of bridges. Among which, fiction pendulum bearings have been widely used in the actual bridge engineering in many countries around the world because of their significant isolation effect, large load and mature technology. In the bridge structure, the stability and reliability of a bearing which as a main force transfer component directly affects the safety performance of the entire bridge. Bearing failure will lead to the overall collapse of the entire bridge, resulting in immeasurable serious consequences. At the same time, the stiffness of the bridge structure will become vestigial when the force components of the upper structure of the bridge or the lower structure of the bridge are damaged, which will lead to the space redistribution of the load, manifested as the change of bearing force condition. Therefore, the long-term safety of the bearing is particularly important for the overall safety of the bridges. For the fiction pendulum isolation bearing, the failure of friction pairs and the fatigue and corrosion of metal components are all related to the overall safety of the bridge as time goes by. From the long-term health situation of the bridge, it is particularly important to monitor the health status of an isolation bearing.

In the prior art, the monitoring of the force of isolation bearing mainly relies on the pressure sensing unit. The pressure data information measured by sensing unit needs to be derived by a lead wire. There is a need to make micro-holes on the bearing to lead out the lead wire, thus causing the overall mechanical properties of the bearing to be affected. As the bridge bearing needs to bear a huge load, even tiny pores will cause huge safety risks. In addition, the replacement of the sensor unit is also a problem faced by the current bearing technology. The sensing unit is usually fixedly connected to the bearing body or embedded in the bearing, if the sensor unit is replaced, the entire bearing needs to be replaced at the same time and leading to a high cost and complicated operation.

### SUMMARY OF THE INVENTION

An object of the invention is to provide a fiction pendulum isolation bearing which capable of monitoring the force condition of the bearing in real time and facilitating replacement of the pressure sensing unit, without affecting mechanical properties of the bearing.

Another object of the present invention is to provide an intelligent bearing and a bearing monitoring system, which can monitor and reflect the health status of the bearing in real time.

The technical ways to solve the above problem by this invention are presented as follow:

The fiction pendulum isolation bearing of the invention comprises a top bearing plate; a bottom bearing plate; a top hinge and a bottom hinge, hinged with each other and arranged between the top bearing plate and the bottom bearing plate; a base plate stacked with one of the top bearing plate and the bottom bearing plate, and at least one pressure sensing unit, arranged between the top bearing plate and the base plate, or between the bottom bearing plate and the base plate.

As a further improvement of the above technical solution, the pressure sensing unit is a nano rubber sensor.

As a further improvement of the above technical solution, the base plate and the nano rubber sensor are arranged below the top bearing plate or above the bottom bearing plate.

As a further improvement of the above technical solution, a nano rubber sensor array is arranged between the top bearing plate and the base plate, or between the bottom bearing plate and the base plate.

As a further improvement of the above technical solution, the nano rubber sensor comprises at least two fabric layers, and nano-conductive rubber filled between two adjacent fabric layers, wherein the nano-conductive rubber is a carbon nanotube doped rubber substrate.

As a further improvement of the above technical solution, the bearing comprises a limit unit arranged on a side of the base plate where a lateral force is sustained.

As a further improvement of the above technical solution, the limit unit is a strip-shaped steel bar or limit block, fixedly connected to the top bearing plate or the bottom bearing plate by bolts, and abutting against a side of the base plate.

The invention further discloses an intelligent bearing, comprising a data acquisition unit, a data output unit, and a fiction pendulum isolation bearing according to claim 1. The data acquisition unit is configured to transmit bearing pressure data measured by a pressure sensing unit to the data output unit.

The invention further discloses a bearing monitoring system, comprising a data acquisition unit, a data output unit, a monitoring center, and a fiction pendulum isolation bearing according to claim 1. The data acquisition unit is configured to transmit bearing pressure data measured by a pressure sensing unit to the data output unit, and the data output unit is configured to transmit the bearing pressure data to the monitoring center.

As a further improvement of the above technical solution, the monitoring center comprises a data receiving unit, a server, a monitoring unit, an analysis unit and a human-computer interaction unit, wherein the data receiving unit is configured to transmit the bearing pressure data of the data output unit to the server, the monitoring unit, the analysis unit and the human-computer interaction unit.

The present invention has the beneficial effects that:

1. The pressure sensing unit is arranged between the top bearing plate and the base plate, or between the bottom bearing plate and the base plate, and therefore it is easy to be replaced. And a real-time monitoring of the force condition for the bearing can be realized.

2. The lead wire of the pressure sensing unit is led out from between the top bearing plate and the base plate, or from between the bottom bearing plate and the base plate, thus there is no need to make micro-holes for the lead wire on the bearing, ensuring that the mechanical properties of the bearing are not affected.

3. The bearing monitoring system of the present invention can transmit the pressure value measured by the pressure sensing unit to the monitoring center in real time, and the monitoring center then monitors and analyzes the pressure data so as to monitor and reflect the health status of the bearing in real time.

### BRIEF DESCRIPTION OF THE DRAWINGS

FIG. 1A-1B is an overall cross-sectional view of a fiction pendulum isolation bearing according to a first embodiment of the present invention, wherein FIG. 1A shows one sensor, and FIG. 1B shows a plurality of sensors;

FIG. 2 is an overall cross-sectional view of a fiction pendulum isolation bearing according to a second embodiment of the present invention;

FIG. 3 is an overall cross-sectional view of a fiction pendulum isolation bearing according to a third embodiment of the present invention;

FIG. 4 is an overall schematic view of a nano rubber sensor of the fiction pendulum isolation bearing according to the present invention; and

FIG. 5 is a schematic view showing connections among modules of a bearing monitoring system according to the present invention.

### DETAILED DESCRIPTION OF THE PRESENT INVENTION

In order to fully understand that the objects, features and effects of the present invention a full and clear description of concepts, specific structures and technical effects produced of the present invention will be made below in connection with embodiments and accompanying drawings. Obviously, the embodiments described are merely a part, but not all embodiments of the present invention. Based on the embodiments of the present invention, other embodiments obtained by the skilled in the art without inventive effort should all belong to the protection scope of the present invention. In addition, all the coupling/connecting relationships mentioned herein do not merely refer to direct connection or coupling of members, but rather a better coupling structures formed by adding or subtracting coupling accessories according to specific implementation. Technical features of the present invention may be combined mutually as long as they are not mutually contradictory.

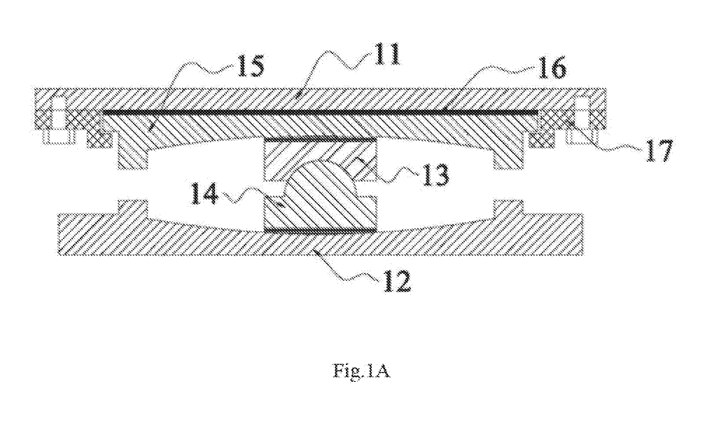

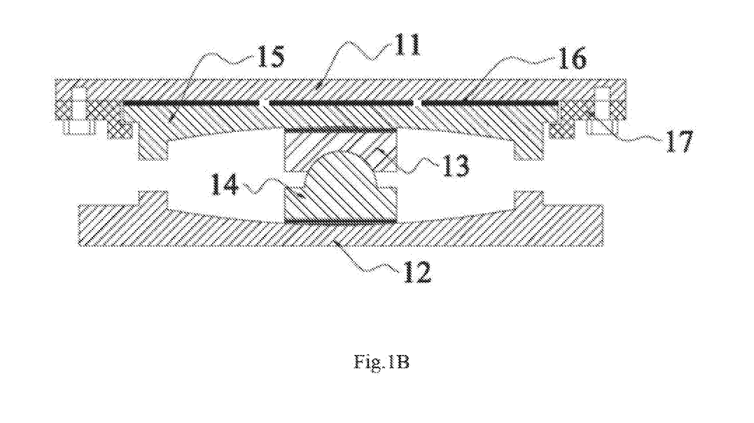

In FIG. 1A a fiction pendulum isolation bearing according to a first embodiment of the present invention is show in detail. As shown in FIG. 1A, the friction pendulum isolation bearing of the present invention comprises a top bearing plate 11, a bottom bearing plate 12, a top hinge 13, a bottom hinge 14, a base plate 15, a nano rubber sensor 16 and a limit unit 17.

The top hinge 13 is slidably connected to the base plate 15, and the bottom hinge 14 is slidably connected to the bottom bearing plate 12. In this embodiment, a low friction material or a low friction coating layer, preferably the low friction material such as polytetrafluoroethylene, is provided between the base plate 15 and the top hinge 13, and between the bottom bearing plate 12 and the bottom hinge 14, such that under action of a temperature load and a seismic load, a sliding may occur between the base plate 15 and the top hinge 13, and between the bottom bearing plate 12 and the bottom hinge 14, to release the temperature load and the seismic load. After the earthquake, the bearing will automatically return to an initial equilibrium position under action of the vertical load on same.

The top hinge 13 has a spherical concave surface, and the bottom hinge 14 has a spherical convex surface, with the same curvature as the concave face, in a position corresponding to where the concave surface is located in the top hinge 13. The top hinge 13 is hinged with the bottom hinge 14 by a spherical hinge formed by the concave surface and the convex surface. Since the concave surface and the convex surface has the same curvature radius and are closely engaged with each other, the bottom bearing plate 12 can be kept horizontal even when the top bearing plate 11 and the base plate 15 are deflected. Alternatively, in a different embodiment, the concave surface can be provided on the bottom hinge 14, while the convex surface with the same curvature is provided on the top hinge 13. That is, any means can be adopted as long as the top hinge 13 and the bottom hinge 14 are connected with a spherical hinge.

In the fiction pendulum isolation bearing of the invention, a nano rubber sensor 16 is adopted to detect the force condition of the bearing in real time, for obtaining the vertical pressure variation value of the bearing. Due to small thickness and simple structure, the nano rubber sensor 16 will not impact the mechanical properties of the bearing. Due to good fatigue resistance and high temperature resistance of the rubber, the nano rubber sensor 16 has a high durability, its alternating stress cycles is more than 50 million times.

According to a preferred embodiment of the present invention, the nano rubber sensor 16 is used as a pressure measuring unit. Optionally, other pressure sensors, such as but not limited to, a strain gages pressure sensor, a ceramic pressure sensor, a diffused silicon pressure sensor, a piezoelectric pressure sensor, etc., can be used as well.

In this preferred embodiment, the base plate 15 and the nano rubber sensor 16 are arranged below the top bearing plate 11. The limit unit 17 is arranged on a side edge of the base plate 15, which is subjected to a lateral force, to limit the relative displacement between the top bearing plate 11 and the base plate 15, so as to ensure the stability of the base plate 15 and pressure sensor 16 in the horizontal direction. In a different embodiment, the base plate 15 can be arranged above the top bearing plate 11, as long as the base plate 15 and the top bearing plate 11 are stacked and the nano rubber sensor 16 is arranged therebetween.

The limit unit 17 is preferably a strip-shaped steel bar or a limit block, which is fixedly connected to the top bearing plate 11 by bolts and abuts against the side edge of base plate 15. It should be appreciated that, the limit unit 17 is not limited to the above-described embodiments in shape, fixed position and mounting, as long as the limiting function desired is achieved. The limit unit 17 and the base plate 15 are connected by bolts for offering facilitation in replacement of the nano rubber sensor 16. In case of replacement, the limit unit 17 is taken off first, and then the top bearing plate 11 together with constructions thereon is jacked up with a jacking device, thus the nano rubber sensor 16 can be replaced.

In order to accurately measure a force condition of the entire bearing and ensure monitoring validity under eccentric load, preferably, an array of the nano rubber sensors 16 are arranged between the top bearing plate 11 and the base plate 15, as shown in FIG. 1B. A high-temperature-resistance shielding lead wire 18 connecting two electrodes of each of the nano rubber sensors 16 is led out from a gap between the base plate 15 and the top bearing plate 11, thus there is no need to make any micro-holes for the lead wire in the bearing, effectively ensuring the mechanical properties of the bearing.

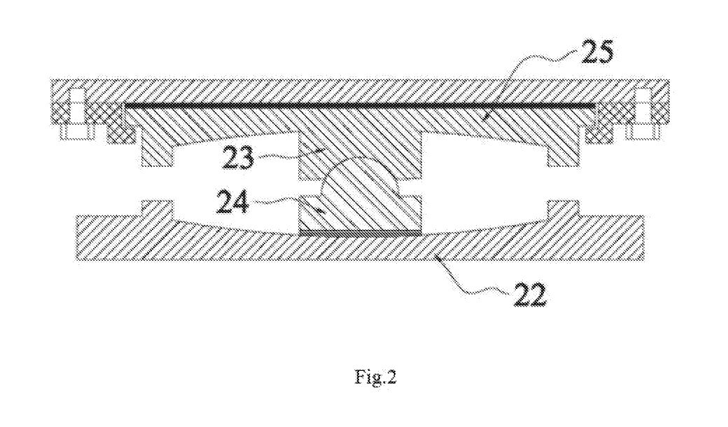

In FIG. 2 a fiction pendulum isolation bearing according to a second embodiment of the present invention is shown. The difference between this embodiment and the first embodiment is that the top hinge 23 is fixedly connected to the base plate 25 to form a whole, but the bottom hinge 24 is still slidably connected to the bottom bearing plate 22, and a low friction material or a low friction coating layer is provided on the sliding contact surface.

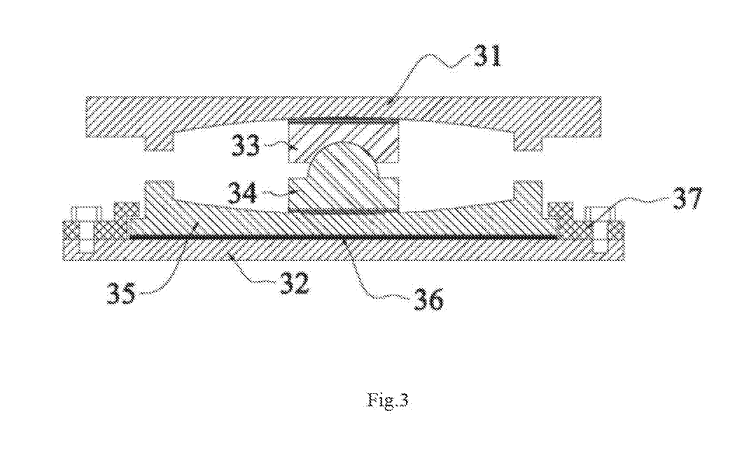

In FIG. 3 a fiction pendulum isolation bearing according to a third embodiment of the present invention is shown. As shown in FIG. 3, the friction pendulum isolation bearing of the present invention comprises a top bearing plate 31, a bottom bearing plate 32, a top hinge 33, a bottom hinge 34, a base plate 35, a nano rubber sensor 36, and a limit unit 37. The difference between this embodiment and the first embodiment is that the nano rubber sensor 36 and the base plate 35 are arranged above the bottom bearing plate 32. Similarly, in a different embodiment, the base plate 35 can be arranged below the bottom bearing plate 32, as long as the base plate 35 and the top bearing plate 11 are stacked and the nano rubber sensor 16 is arranged therebetween.

In the embodiment, while replacement of the nano rubber sensor 36 is required, the limit unit 37 is taken off first, and then the top bearing plate 31, the constructions above the top bearing plate 31, the top hinge 33, the base plate 35 and the bottom hinge 34 are simultaneously jacked up to allow the replacement of the nano rubber sensor 36 to be conducted. Since the top bearing plate 31 and the top hinge 33, the top hinge 33 and the bottom hinge 34, and the bottom hinge 34 and the base plate 35 are in non-fixed connection, preferably a locking mechanism is used to lock the above components together as one piece during jacking, in order to facilitate the overall jacking of the components.

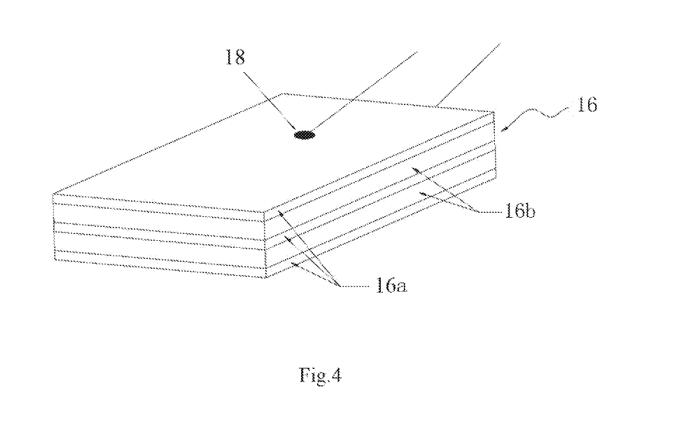

FIG. 4 schematically shows an overall structure of the nano rubber sensor 16 of the fiction pendulum isolation bearing of the invention.

The way the nano rubber sensor works is that: the nano rubber sensor is deformed under the action of an external load, and thus distances between conductive particles inside the conductive rubber, consequently a conductive network formed by the conductive particles, are changed, exhibiting changes in the resistivity and resistance of the conductive rubber, to cause changes in the measurement of electrical signals. Then, according to the piezoresistive characteristics of the conductive rubber, the stress states of a pressure bearing surface can be derived.

Preferably, the nano rubber sensor 16 is of a multilayer structure, wherein as a skeleton layer, a plurality of high strength fabric layers 16a are distributed at intervals from top to bottom, and a nano-conductive rubber 16b of a certain thickness is filled between two adjacent fabric layers 16a. Due to dense texture, and a certain thickness, elasticity and strength, the fabric layers 16a can satisfy the requirements of elastic deformation under a high pressure without being damaged. Preferably, the fabric layers 16a are made of elastic fibers, such as medium or high spandex, high elastic nylon, etc. In addition, gaps in the texture of the fabric layers 16a, which is formed by the vertical and horizontal fibers, ensure that a nano-conductive rubber solution covered on the fabric layers 16a can infiltrate into the gaps during preparation, such that the integrity of the structure is enhanced. A rubber substrate material of the nano-conductive rubber 16b is polydimethylsiloxane rubber (PDMS) consisting of basic constituents and a curing agent in a mixing ratio of 10:1. Conductive fillers are carbon nanotubes, preferably multi-walled carbon nanotubes (MWCNT). The mass percentage of multi-walled carbon nanotubes is between 8% and 9%.

Due to the high strength fabric layers 16a provided in the nano rubber sensor 16 as a stiff skeleton, the strength and toughness of the nano rubber sensor 16 under a high pressure of 0 to 50 MPa are significantly improved, tearing is avoided and the stability and repeatability of such sensing unit under high pressure are guaranteed.

The preparation of the nano rubber sensor is carried out mainly by solution blending and molding. A specific preparation method comprises the following steps:

S1, ingredient mixing: weighing basic constituents of polydimethylsiloxane rubber (PDMS), curing agent and carbon nanotubes in accordance with a mass ratio, pouring them into a mixer, and grinding and mixing them mechanically at room temperature, until the carbon nanotubes are uniformly distributed in the rubber substrate, to make the nano-conductive rubber solution.

S2, synthesis: preparing a plurality of high-strength fabric pieces of the same size, laying a fabric piece/layer on a bottom plate of a mold, uniformly coating the nano-conductive rubber solution prepared in S1 onto the fabric piece at a certain thickness, and then laying another fabric piece on the nano-conductive rubber solution; repeating the process of coating the nano-conductive rubber solution and additionally laying the fabric piece until a thickness desired for the nano-conductive rubber sensing element is achieved.

S3, curing: placing the top plate of the mold on the uppermost fabric layer of the uncured nano rubber sensor; by a connection between the top and bottom plates of the mold, applying a certain pressure to the nano-conductive rubber material to ensure its thickness uniformity and compactness; and placing the mold in a container at 60° C., vacuuming the container and maintaining the condition for at least 300 min.

After the nano rubber sensor is cured, the cured nano rubber sensor is of a sheet type and can be cut into desired sizes and shapes by machining tools according to design requirements of the sensor. After electrodes and insulating protective layers are connected, a sheet-type flexible nano-conductive rubber pressure sensor having a large measuring range is fabricated.

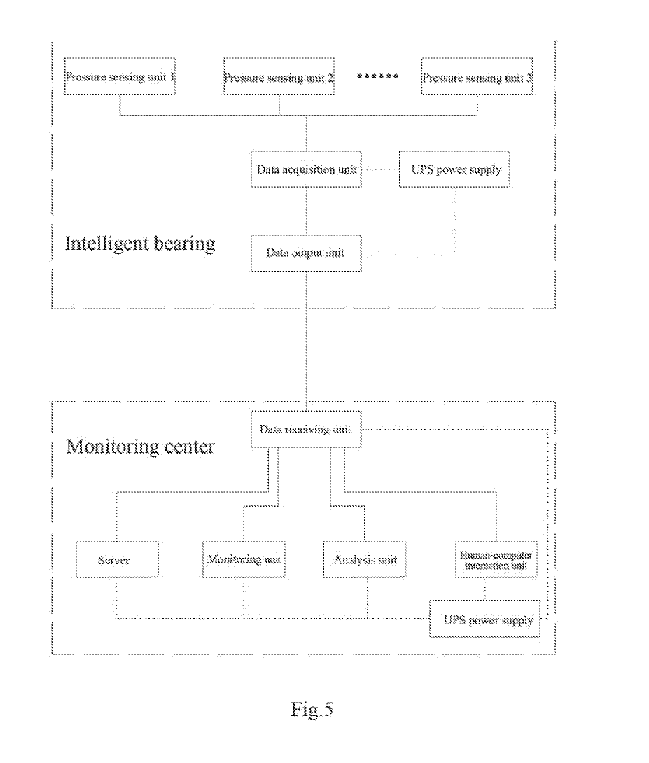

FIG. 5 schematically illustrates the module connections of a bearing monitoring system of the invention. The bearing monitoring system of the invention comprises an intelligent bearing and a monitoring center.

The intelligent bearing comprises the fiction pendulum isolation bearing as described above, a data acquisition unit, a data output unit, and a UPS power supply. The data acquisition unit is configured to acquire pressure data of each of the nano rubber sensors in the fiction pendulum isolation bearing. The data output unit is preferably an optical wireless switch, configured to transmit the pressure data to the monitoring center. The UPS is configured to provide uninterrupted power to these electricity-consuming modules in the intelligent bearing.

The monitoring center comprises a data receiving unit, a server, a monitoring unit, an analysis unit, a human-computer interaction unit and a UPS power supply. The data receiving unit is preferably an optical wireless switch, configured to receive the pressure data transmitted by the data output unit. The data receiving unit is configured to transmit the received data to the server, the monitoring unit, the analysis unit and the human-computer interaction unit. The server is configured to manage and control the data, the monitoring unit is configured to monitor the data in real time, and the analysis unit is configured to evaluate and analyze the data. The UPS power supply is configured to provide uninterrupted power to these electricity-consuming modules in the monitoring center.

Through the acquisition, transmission, monitoring and analysis of the dada performed on the bearing, the bearing monitoring system can instantly recognize and determine the health status of the bearing, thereby ensuring the safe use of the bearing.

Some preferred embodiments of the invention have been described above, but the present invention is not limited thereto. Numerous variations, substitutions and equivalents may be made by those skilled in the art without departing from the spirit of the invention and should all fall within the scope defined by the claims of the present application.

1. A fiction pendulum isolation bearing, comprising:
a top bearing plate;
a bottom bearing plate;
a top hinge and a bottom hinge, hinged with each other and arranged between the top bearing plate and the bottom bearing plate;
a base plate stacked with one of the top bearing plate and the bottom bearing plate; and
at least one pressure sensing unit, arranged between the top bearing plate and the base plate, or between the bottom bearing plate and the base plate.

2. The fiction pendulum isolation bearing according to claim 1, wherein the pressure sensing unit is a nano rubber sensor.

3. The fiction pendulum isolation bearing according to claim 2, wherein the base plate and the nano rubber sensor are arranged below the top bearing plate or above the bottom bearing plate.

4. The fiction pendulum isolation bearing according to claim 2, wherein a nano rubber sensor array is arranged between the top bearing plate and the base plate, or between the bottom bearing plate and the base plate.

5. The fiction pendulum isolation bearing according to claim 2, wherein the nano rubber sensor comprises at least two fabric layers, and nano-conductive rubber filled between two adjacent fabric layers, wherein the nano-conductive rubber is a carbon nanotube doped rubber substrate.

6. The fiction pendulum isolation bearing according to claim 1, further comprising a limit unit arranged on a side of the base plate where a lateral force is sustained.

7. The fiction pendulum isolation bearing according to claim 6, wherein the limit unit is a strip-shaped steel bar or limit block, fixedly connected to the top bearing plate or the bottom bearing plate by bolts, and abutting against a side of the base plate.

8. An intelligent bearing, comprising:
a data acquisition unit;
a data output unit; and
a fiction pendulum isolation bearing according to claim 1; and
wherein the data acquisition unit is configured to transmit bearing pressure data measured by a pressure sensing unit to the data output unit.

9. A bearing monitoring system, comprising:
a data acquisition unit;
a data output unit;
a monitoring center; and
a fiction pendulum isolation bearing according to claim 1; and
wherein the data acquisition unit is configured to transmit bearing pressure data measured by a pressure sensing unit to the data output unit, and the data output unit is configured to transmit the bearing pressure data to the monitoring center.

10. The bearing monitoring system according to claim 9, wherein the monitoring center comprises a data receiving unit, a server, a monitoring unit, an analysis unit and a human-computer interaction unit, wherein the data receiving unit is configured to transmit the bearing pressure data of the data output unit to the server, the monitoring unit, the analysis unit and the human-computer interaction unit.
